(19) United States
(12) Patent Application Publication
(10) Pub. No.: US 2016/0344975 A1
(43) Pub. Date: Nov. 24, 2016

(54) IMAGE PROCESSING ELECTRONIC DEVICE AND NON-TRANSITORY COMPUTER READABLE STORAGE MEDIUM

(71) Applicant: ASUSTeK COMPUTER INC., Taipei (TW)

(72) Inventors: Hendrik Hendrik, Taipei City (TW); Guan-De Lee, Taipei City (TW); Wei-Po Lin, Taipei City (TW); Hsiu-Jui Kuo, Taipei City (TW)

(21) Appl. No.: 15/158,607

(22) Filed: May 19, 2016

Related U.S. Application Data
(60) Provisional application No. 62/164,543, filed on May 21, 2015.

(30) Foreign Application Priority Data
Apr. 12, 2016 (CN) 201610223823.X

(51) Int. Cl. H04N 7/14

(52) U.S. Cl. CPC H04N 7/147

(57) ABSTRACT

An electronic device and a non-transitory computer readable storage medium are provided. After the real-time communication interface is enabled, the source filter obtains the image adjusting parameter when that the source filter is driven is detected. The source filter applies the image adjusting parameter to an image data captured by the image capturing unit, and then the adjusted image data is obtained. The real-time communication interface outputs the adjusted image data.

### CROSS-REFERENCE TO RELATED APPLICATION

This application claims the priority benefit of U.S. provisional application Ser. No. 62/164,543, filed on May 21, 2015 and China application serial No. 201610223823.X, filed on Apr. 12, 2016. The entirety of each of the above-mentioned patent applications is hereby incorporated by reference herein and made a part of specification.

### BACKGROUND OF THE INVENTION

1. Field of the Invention

The invention relates to an electronic device with an image processing function and a non-transitory computer readable storage medium.

2. Description of the Related Art

As the development of Internet and the information environment, the real-time communication software (such as Skype, Facebook Messenger, Line, QQ, Viber) is widely used to transmit messages. The real time communication software provides the function of chatting, sharing videos, communicating via voice and texts with others. Currently, the interface of the video capturing device and/or the audio capturing device is utilized to transmit the video and audio streaming to allow users to have the video communication with others via the real time communication software.

### BRIEF SUMMARY OF THE INVENTION

According to a first aspect of the present disclosure, an image processing electronic device, comprising: an image capturing unit for capturing image data; a storage unit, including a plurality of execution modules; and a processor, coupled to the image capturing unit and the storage unit, wherein the processor drives the execution modules to process the image data, the execution modules include a source filter and a real-time communication module, the source filter simulates the image capturing unit, and the real-time communication module provides the real-time communication interface; when the real-time communication interface is enabled, the source filter obtains an image adjusting parameter when the processor detects the source filter is driven; after the image capturing unit captures image data, the source filter applies the image adjusting parameter to the image data to produce adjusted image data; and the real-time communication module outputs an adjusted image data.

According to a second aspect of the present disclosure, a non-transitory computer readable storage medium of an image processing electronic device having at least a program command stored therein, and after the at least program command loads to the image processing electronic device, the non-transitory computer readable storage medium is configured to: enable a real-time communication interface; obtain an image adjusting parameter via a driven source filter; apply the image adjusting parameter to image data captured by an image capturing unit via the source filter to obtain an adjusted image data; and output an adjusted image data via the real-time communication interface.

In sum, when the real-time communication interface is enabled, after the image data is processed, the outputted adjusted image data is viewed by the user at the receiving terminal. As a result, the user at the receiving terminal can view the processed real-time image immediately.

### BRIEF DESCRIPTION OF THE DRAWINGS

These and other features, aspects and advantages of the invention will become better understood with regard to the following embodiments and accompanying drawings.

FIG. 1 is a block diagram showing an image processing electronic device in an embodiment;

FIG. 2 is a schematic diagram showing an architecture of an image processing software in an embodiment; and

FIG. 3 is a flow chart showing an image data processing method in an embodiment.

### DETAILED DESCRIPTION OF THE EMBODIMENTS

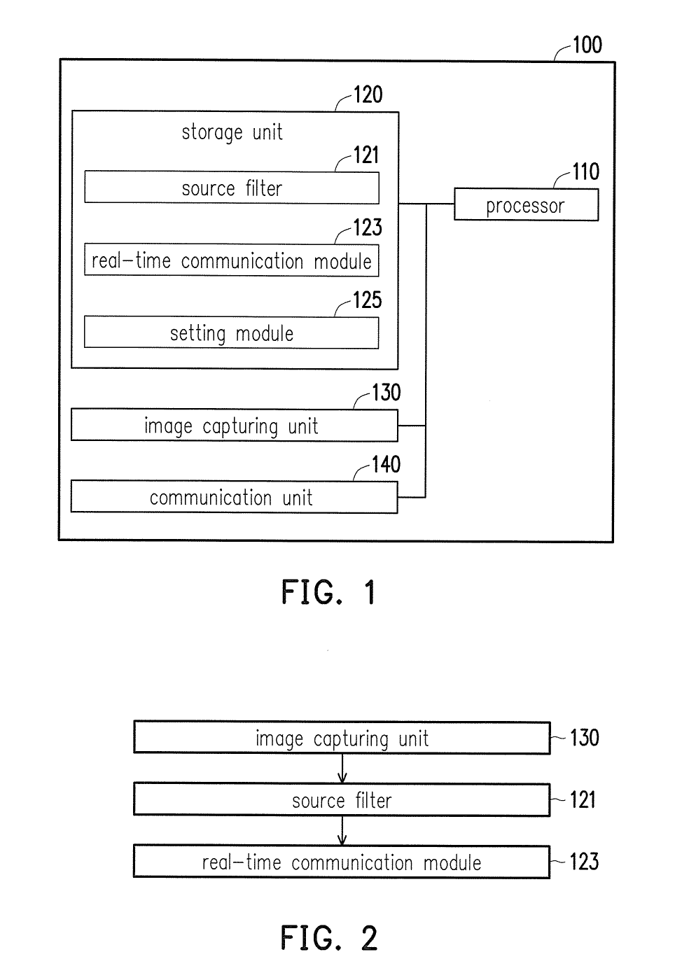

FIG. 1 is a block diagram showing an image processing electronic device in an embodiment. Please refer to FIG. 1, an image processing electronic device 100 includes a processor 110, a storage unit 120, an image capturing unit 130 and a communication unit 140. The processor 110 is coupled to the storage unit 120, the image capturing unit 130 and the communication unit 140.

In an embodiment, the processor 110 is a central processing unit (CPU), a graphic processing unit (GPU),a physics processing unit (PPU), a programmable microprocessor, an embedded control chip, a digital signal processor (DSP), an application specific integrated circuit (ASIC), which is not limited herein.

In an embodiment, the image capturing unit 130 is a camera, and the image capturing unit 130 utilizes a charge coupled device (CCD) lens or a complementary metal oxide semiconductor transistors (CMOS) lens, which is not limited herein.

In an embodiment, the storage unit 120 is a non-volatile memory, a random access memory (RAM) or a hard disk, which is not limited herein. In an embodiment, the storage unit 120 includes a plurality of execution modules, and the execution modules include one or more code segments. The processor 110 drives the execution modules to execute the corresponding functions, for completing the processing of image data. In an embodiment, the execution modules include a source filter 121 and a real-time communication module 123. The source filter 121 processes the data captured by the image capturing unit 130, and then a processed result is sent to the real-time communication module 123. The real-time communication module 123 includes a real-time communication interface. In an embodiment, the real-time communication interface is an interface of the real time communication software (such as Skype, Facebook Messenger, Line, QQ, Viber) which supports Voice over IP (VoIP) technology. In an embodiment, the source filter 121 is an application (APP) used to simulate a driver of the image capturing unit, or a virtual camera.

For example, a virtual camera is set based on DirectShow architecture, and the virtual camera is used as the source filter 121, thus the source filter 121 is utilized without changing the architecture of the real-time communication module 123. In other words, the real-time communication module 123 directly detects the external or built-in image capturing unit 130 and the virtual camera (such as the source filter 121) for users to choose.

In an embodiment, the execution modules further include a setting module 125 which provides a parameter setting interface. In an embodiment, the parameter setting interface includes a display area and a parameter setting area. The display area displays the real-time or non-real-time image reference data. The parameter setting area provides a plurality of image editing tools. The image adjusting parameter is obtained through the image editing tools editing the image reference data.

The architecture of the image data transmission among the source filter 121, the real-time communication module 123 and the image capturing unit 130 is shown hereafter. FIG. 2 is a schematic diagram showing architecture of the image processing software in an embodiment. Please refer to FIG. 2, the source filter 121 is configured between the image capturing unit 130 and the real-time communication module 123. When the source filter 121 is driven, the source filter 121 intercepts the image data outputted by the image capturing unit 130 and processes the outputted image data. Then, a processed result is sent to the real-time communication module 123.

In an embodiment, the communication unit 140 is a hardware that supports wire protocols or wireless protocols for the image processing electronic device 100 to connect to communicating systems. In an embodiment, the communication unit 140 is a network card, a subscriber identity module (SIM) card, or a Wi-Fi module, which is not limited herein.

The steps of an image data processing method are further illustrated cooperating with the image processing electronic device 100.

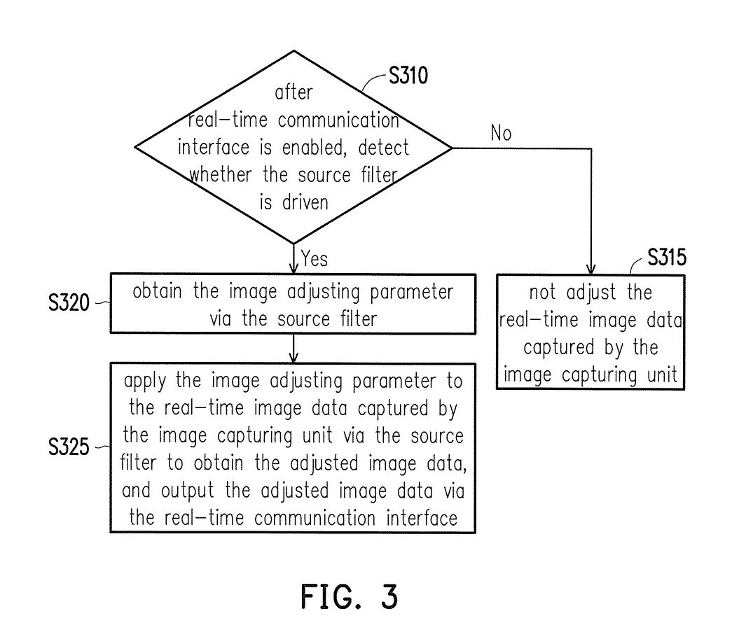

FIG. 3 is a flow chart showing an image data processing method in an embodiment. Please refer to FIG. 1 and FIG. 3, in step S310, after the real-time communication interface is enabled, the processor 110 detects whether the source filter 121 is driven. For example, the real-time communication module 123 provides two options of the video capturing devices for the user, one option is driving the image capturing unit 130, the other option is driving the source filter 121 (such as the virtual camera).

In an embodiment, the step of enabling the real-time communication interface further includes: the processor 110 enabling the real-time communication module 123 based on the procedures or shortcuts clicked by the user to enable the real-time communication interface; or the processor 110 enabling the real-time communication module 123 via the parameter setting interface to enable the real-time communication interface.

When the processor 110 detects that the source filter 121 is not driven, as shown in step S315, the processor 110 does not adjust the image data captured by the image capturing unit 130. In other words, when the source filter 121 is not driven, the real-time communication module 123 executes according to the original setting.

When the processor 110 detects that the source filter 121 is driven, in step S320, the image adjusting parameter is obtained via the source filter 121. In an embodiment, the image adjusting parameter is set via the parameter setting interface of the setting module 125. The image adjusting parameter is pre-set and stored in the storage unit 120, or the image adjusting parameter is set in real time.

The time of enabling the parameter setting interface is before or after the real-time communication interface is enabled. In an embodiment, the processor 110 enables the parameter setting interface according to a command before the real-time communication module 123 is enabled, and then the image adjusting parameter is set in advance. Then, the real-time communication module 123 is driven via the processor when the parameter setting interface transmits a driver command to the processor. In an embodiment, an option is set in the parameter setting interface, the processor receives the driver command from the parameter setting interface to driver the real-time communication module when the option of the parameter setting interface is chosen, and then the real-time communication interface is enabled.

In an embodiment, after the processor 110 drives the real-time communication module 123 to enable the real-time communication interface, when the processor 110 detects that the source filter 121 is driven, the parameter setting interface is enabled via the source filter 121. As a result, the image adjusting parameter is obtained via the parameter setting interface. In an embodiment, the parameter setting interface obtains the pre-set image adjusting parameter from the storage unit 120. In an embodiment, the user can set the image adjusting parameter via the parameter setting interface.

Further, the setting of the image adjusting parameter via the parameter setting interface is illustrated. In an embodiment, the parameter setting interface includes a display area and a parameter setting area. The display area displays the real-time image reference data or non-real-time image reference data, and the parameter setting area provides a plurality of image editing tools. In an embodiment, at least one of the image editing tools includes an electronic makeup function. Then, the image reference data is edited by the image editing tools to obtain the image adjusting parameter. The image reference data used in the parameter setting interface is the image data, or pre-stored image data, which is not limited herein.

For example, a captured image is displayed at the display area via the parameter setting interface (or the image capturing unit 130 captures a real-time image directly), and then the image is edited by the image editing tool. For example, the parameter of the image, such as the exposure, the luminance, the contrast, is adjusted via the image editing tool. In addition, the electronic makeup function of the image editing tool is applied to makeup the face on the captured image. After the editing is finished, the parameter setting interface generates the image adjusting parameter based on the editing action.

In addition, the image adjusting parameter is stored to the storage unit 120 via the parameter setting interface. Then, when that the source filter 121 is detected driven while the real-time communication module 123 is continually used, the source filter 121 can obtain the image adjusting parameter from the storage unit 120.

In step S325, the source filter 121 applies the image adjusting parameter to the image data captured by the image capturing unit 130. Then, the adjusted image data is obtained, and the adjusted image data is outputted via the real-time communication interface. In other words, the adjusted image data is outputted via the real-time communication module 123. In an embodiment, the image data is a static image or a dynamic image. When the image data is the video data, the source filter 121 processes each frame of the video data. In other words, the image adjusting parameter is applied on each frame of the video data. If the image adjusting parameter is generated based on the make-up action, the image adjusting parameter includes facial features. Accordingly, the source filter 121 further applies the image adjusting parameter to the image data based on the facial features, and then the make-up matches with the location of the corresponding features.

In an embodiment, after the adjusted image data is obtained, the real-time communication module 123 transmits the adjusted image data to the remote device through the communication unit 140 based on the streaming protocol, and then the user of the remote device can view the adjusted image data.

In an embodiment, the above method is implemented by a non-transitory computer readable storage medium. The non-transitory computer readable storage medium of the image processing electronic device having at least a program command stored therein, and after the at least program command loads to the image processing electronic device, the non-transitory computer readable storage medium is configured to: enable a real-time communication interface; obtain an image adjusting parameter via a driven source filter; apply the image adjusting parameter to image data captured by an image capturing unit via the source filter to obtain an adjusted image data; and output the adjusted image data via the real-time communication interface.

It should be noted that the image capturing unit, storage unit, the setting module, the real-time communication module and the communication unit described above may be hardware components consisting of one or more circuits, but not limited thereto.

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. An image processing electronic device, comprising:
an image capturing unit for capturing image data;
a storage unit, including a plurality of execution modules; and
a processor, coupled to the image capturing unit and the storage unit, wherein the processor drives the execution modules to process the image data, the execution modules include a source filter and a real-time communication module, the source filter simulates the image capturing unit, and the real-time communication module provides the real-time communication interface;
when the real-time communication interface is enabled, the source filter obtains an image adjusting parameter when the processor detects the source filter is driven; after the image capturing unit captures image data, the source filter applies the image adjusting parameter to the image data to produce adjusted image data; and the real-time communication module outputs an adjusted image data.

2. The image processing electronic device according to claim 1, wherein the execution modules further include:
a setting module, providing a parameter setting interface, wherein when the parameter setting interface is enabled, the image adjusting parameter is set via the parameter setting interface.

3. The image processing electronic device according to claim 2, wherein when the real-time communication interface is enabled, and the processor detects that the source filter is driven, the parameter setting interface is enabled via the source filter, and the image adjusting parameter is set via the parameter setting interface.

4. The image processing electronic device according to claim 2, wherein the processor enables the parameter setting interface according to a command before the real-time communication is enabled, and the image adjusting parameter is set via the parameter setting interface; and after the parameter setting interface is enabled, the real-time communication module is driven via the processor when the parameter setting interface transmits a driver command to the processor.

5. The image processing electronic device according to claim 2, wherein after the image adjusting parameter is set via the parameter setting interface, the image adjusting parameter is stored to the storage unit via the parameter setting interface, and the source filter obtains the image adjusting parameter from the storage unit when the source filter is detected driven.

6. The image processing electronic device according to claim 1, wherein the image data is a static image or a dynamic image, and the source filter is a virtual camera.

7. The image processing electronic device according to claim 1, wherein the real-time communication module outputs the adjusted image data based on a streaming protocol.

8. A non-transitory computer readable storage medium of an image processing electronic device having at least a program command stored therein, and after the at least program command loads to the image processing electronic device, the non-transitory computer readable storage medium is configured to:
enable a real-time communication interface;
obtain an image adjusting parameter via a driven source filter;
apply the image adjusting parameter to image data captured by an image capturing unit via the source filter to obtain an adjusted image data; and
output the adjusted image data via the real-time communication interface.

9. The non-transitory computer readable storage medium according to claim 8, wherein the non-transitory computer readable storage medium is further configured to:
provide a parameter setting interface and set the image adjusting parameter via the parameter setting interface when the parameter setting interface is enabled.

10. The non-transitory computer readable storage medium according to claim 9, wherein after setting the image adjusting parameter via the parameter setting interface, the non-transitory computer readable storage medium is further configured to:
store the image adjusting parameter to a storage unit via the parameter setting interface, and obtain the image adjusting parameter via the source filter from the storage unit when the source filter is detected driven.

11. The non-transitory computer readable storage medium according to claim 8, wherein after the real-time communication interface is enabled, the non-transitory computer readable storage medium is further configured to:
enable a parameter setting interface via the source filter when the source filter is driven detected, and set the image adjusting parameter via the parameter setting interface.

12. The non-transitory computer readable storage medium according to claim 11, wherein after setting the image adjusting parameter via the parameter setting interface, the non-transitory computer readable storage medium is further configured to:
store the image adjusting parameter to a storage unit via the parameter setting interface, and obtain the image adjusting parameter via the source filter from the storage unit when that the source filter is detected driven.

13. The non-transitory computer readable storage medium according to claim 8, wherein the image data is a static image or a dynamic image, and the source filter is a virtual camera.

14. The non-transitory computer readable storage medium according to claim 8, wherein the adjusted image data is outputted based on a streaming protocol.
